(19) United States
(12) Patent Application Publication
(10) Pub. No.: US 2007/0139606 A1
(43) Pub. Date: Jun. 21, 2007

(54) Display device and method of manufacturing the same

(76) Inventors: Sang-il Kim, Gyeonggi-do (KR); Kyu-ha Chung, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/604,055

(22) Filed: Nov. 22, 2006

(30) Foreign Application Priority Data
Nov. 23, 2005 (KR) 2005-0112112

(51) Int. Cl. G02F 1/1333

(52) U.S. Cl. 349/158

(57) ABSTRACT

A thinner display device comprises: a plastic insulating substrate; a plurality of insulating substrates disposed opposite to the plastic insulating substrate; and a plurality of TFTs formed on the plastic insulating substrate which displays an image on various sides.

### CROSS-REFERENCE TO RELATED APPLICATIONS

This application claims the benefit of Korean Patent Application No. 10-2005-0112112, filed on Nov. 23, 2005, in the Korean Intellectual Property Office, the disclosure of which is incorporated herein by reference.

### FIELD OF THE INVENTION

The present invention relates to a display device and, more particularly, to a display device and a method of manufacturing the same to display an image on various sides.

### DESCRIPTION OF THE RELATED ART

Among flat panel display devices, the LCD comprises a first substrate where TFTs are formed, a second substrate facing the first substrate and a liquid crystal layer interposed between the two substrates and a backlight unit. To display an image on two or more surfaces, for example, on an inner screen and an outer screen in a cellular phone, a flexible printed circuit board (FPCB) connecting two LCD panels is bent so that the LCD panels face opposite directions. The two LCD panels are adhered to a flexible plastic insulating substrate leaving out a connecting part of the flexible plastic insulating substrate, and then the connecting part is bent. Generally, a driving circuitry parts must be provided for each of the separate LCD panels or the FPCB must be connected to each of the LCD panels. Alternatively, separate plastic insulating substrates must be provided. These methods complicate the manufacturing process and add to the thickness of the display device.

### SUMMARY OF THE INVENTION

Accordingly, it is an aspect of the present invention to provide a thinner and more easily manufactured display device capable of displaying an image on different surfaces. A plurality of TFTs are disposed on a plastic insulating substrate disposed between a backlight unit and the plurality of insulating substrates.

### BRIEF DESCRIPTION OF THE DRAWINGS

The above and/or other objects, features and advantages of the present invention will become apparent from a reading of the ensuing description together with the drawings in which:

FIG. 1 is a sectional view of a display device according to a first embodiment of the present invention;

FIG. 2 is an enlarged sectional view of the display device according to the first embodiment of the present invention;

FIG. 3 is a plan view of the display device before being bent according to the first embodiment of the present invention;

FIG. 4 is a flow chart to illustrate a method of manufacturing the display device according to the first embodiment of the present invention;

FIG. 5 is a sectional view of a display device according to a second embodiment of the present invention;

FIG. 6 is an enlarged sectional view of the display device according to the second embodiment of the present invention;

FIG. 7 is a flow chart to illustrate a method of manufacturing the display device according to the second embodiment of the present invention;

FIGS. 8 through 14 are sectional views of a display device according to a third through a ninth embodiments of the present invention, respectively; and

FIG. 15 is a perspective view of an electronic equipment comprising the display device according to the present invention.

### DETAILED DESCRIPTION

In the following description, if a layer is said to be formed ‘on’ another layer, then a third layer may be disposed between the two layers or the two layers may be contacted with each other. In other words, it will be understood that when an element such as a layer, film, region, or substrate is referred to as being “on” another element, it can be directly on the other element or intervening elements may also be present.

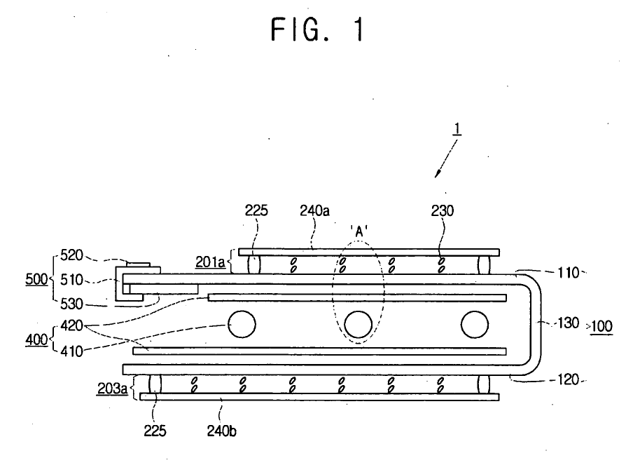

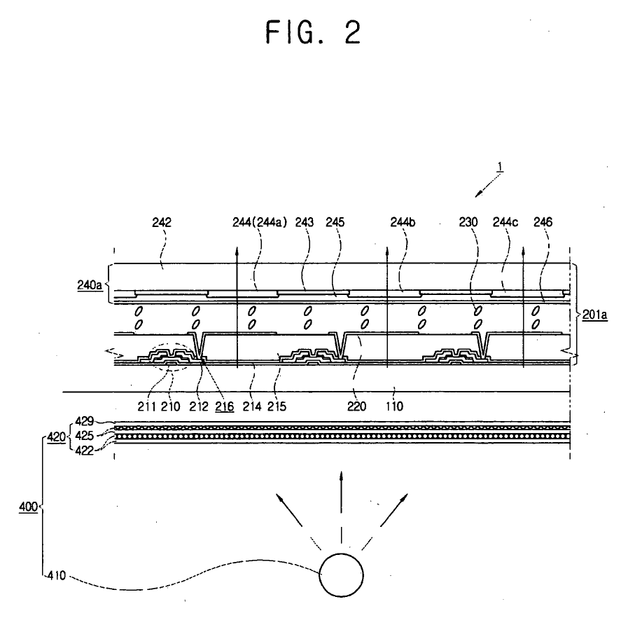

Referring to FIGS. 1 and 2, a display device 1 comprises a single plastic insulating substrate 100, a first display 201a and a second display 203a formed on substrate 100, a backlight unit 400 providing light to displays 201a and 203a, and driving circuitry 500 disposed at one end of substrate 100.

Substrate 100 comprises a first substrate part 110, a second substrate part 120 and a connecting part 130 connecting the two. Display 201a is disposed on substrate part 110 of substrate 100 with driving circuitry 500 connected at one end of substrate part 110. Display 203a is disposed on substrate part 120 of substrate 100. Connecting part 130 connects substrate parts 110 and 120 and is bent so that displays 201a and 203a are parallel with each other.

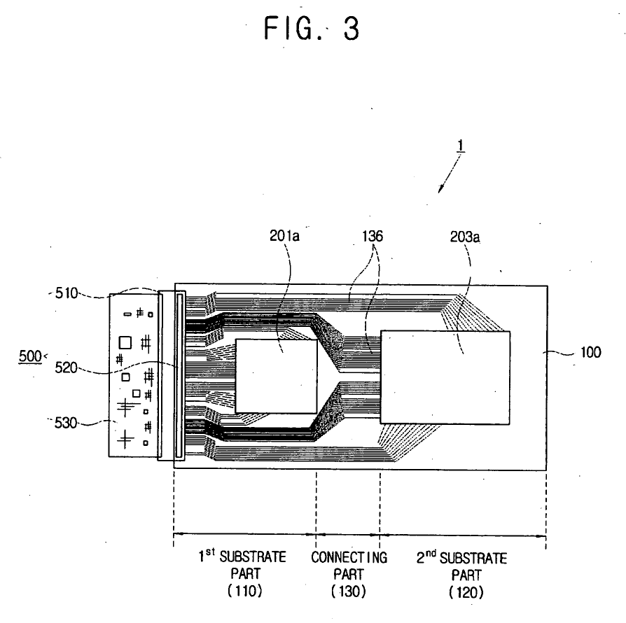

As shown in FIG. 3, a signal line assembly 136 is formed on connecting part 130 to transmit the driving signals from driving circuitry 500 to display 203a on substrate part 120. Signal line assembly 136 is formed of the same material as a gate electrode 211 and a drain electrode 212.

Referring to FIG. 2, display 201a comprises a plurality of TFTs 210 each having a drain electrode 212, a pixel electrode 220 electrically connected to drain electrode 212, a first counter-counter-substrate 240a adhered opposite to substrate part 110 by sealant 225 (shown in FIG. 1), and a liquid crystal layer 230 interposed between substrate part 110 and counter-counter-substrate 240a. One LCD panel comprises substrate part 110 and display 201a. Likewise, the other LCD panel comprises substrate part 120 and display 203a. Thus, the display device 1 according to the first embodiment of the present invention comprises two LCD panels which may be of different size.

Each of the TFTs 210 comprises a gate electrode 211 and a drain electrode 212, wherein gate electrode 211 is of the same material as the signal line assembly 136. The semiconductor layer of TFT 210 may be made of amorphous silicon, polysilicon or an organic semiconductor. A passivation layer 214 of silicon nitride (SiNx) is formed on substrate part 110 and is partially removed to form a drain contact hole 216 exposing the drain electrode 212 therethrough. An organic layer 215 is formed on passivation layer 214 that may comprise one of benzocyclobutene (BCB), olefin, acrylic resin, polyimide, tefron, cytop and perfluorocyclobutene. Organic layer 215 is partially removed to form drain contact hole 216 as well.

A pixel electrode 220, electrically connected to the drain electrode 216 of TFT 210, is formed on the organic layer 215. Pixel electrode 220 comprises a transparent conductive material such as indium tin oxide (ITO) or indium zinc oxide (IZO).

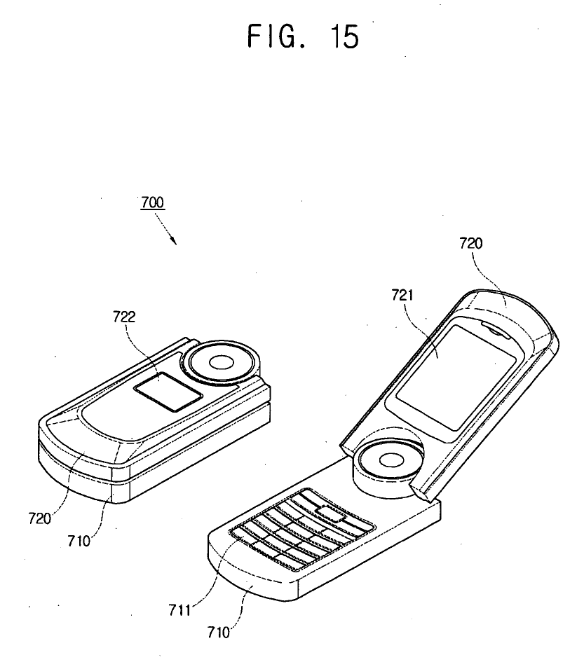

Counter-substrate 240a is adhered to substrate part 110 by sealant 225 and comprises an insulating material such as glass, quartz, ceramic, plastics or the like. Counter-substrate 240a may advantageously be smaller in size than substrate part 110 to provide room for driving circuitry 500 at one end of substrate part 110 to accommodate the design of electronic equipment 700 shown in FIG. 15 which may have an outer screen 722 that may be smaller than inner screen 721.

Counter-substrate 240a comprises a base substrate 242 of an insulating material such as glass, quartz, ceramic, plastics or the like, a black matrix 243, a color filter layer 244, an overcoat layer 245 and a common electrode 246. Black matrix 243, comprising chrome oxide or an organic material having a black pigment, is formed on substrate 242 between color filters 244, has a lattice shape and blocks light from the channel region of the TFTs. Color filters 244 comprises three sub-layers 244a, 244b and 244c which have different colors. Overcoat layer 245 is formed on black matrix 243 and color filter layer 244 and provides a planar surface.

Common electrode 246 is formed on overcoat layer 245 and comprises a transparent conductive material, such as ITO or IZO that, together with pixel electrode 220, applies voltage to liquid crystal layer 230 to vary the orientation of the liquid crystal molecules in layer 230.

Polarization plates (not shown) are adhered to external surfaces of substrate part 110, counter-substrate 240a, substrate part 120, and the second counter-counter-substrate 240b.

A backlight unit 400 is disposed between substrate part 110 and substrate part 120 and comprises a plurality of lamps 410 directing light to displays 201a and 203a and a pair of light control members 420.

In a first embodiment of the present invention, lamps 410 are cold cathode fluorescent lamp (CCFL). Alternatively, other linear light sources such as an external electrode fluorescent lamp (EEFL) may be used.

Light control member 420 comprises a diffusion plate 422 diffusing the light from the lamps 410, a prism film 425 collecting the light diffused by diffusion plate 422 in a perpendicular direction to a surface of substrate part 110, and a protection film 429 protecting the prism film 425 against scratches.

Driving circuitry 500, shown in FIG. 1, comprises a flexible printed circuit (FPC) 510, a driving chip 520 mounted on FPC 510, and a printed circuit board (PCB) 530 connected to FPC 510. Driving circuitry 500 may be a chip on film (COF). Alternatively, any known type, such as a tape carrier package (TCP), a chip on glass (COG) or the like, may be used. Further, driving circuitry 500 may be formed on substrate part 110.

Display device 1 according to the first embodiment of the present invention may display an image on both sides using the single driving circuitry 500. Further, connecting part 130 of substrate 100 is bent, so that an additional FPC is not needed to connect two LCD panels as was required in the prior art, and there is no need for an additional plastic insulating substrate for the LCD panels. Accordingly, a thinner and more easily manufactured display is provided for displaying image on different sides.

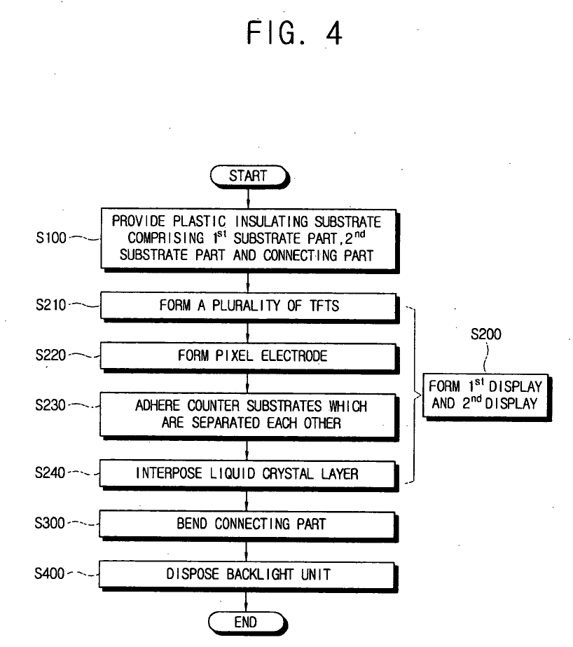

FIG. 4 is a flow chart to illustrate a method of manufacturing a display device according to the first embodiment of the present invention. First, at step S100, a single plastic insulating substrate 100 is provided having, before it is bent, a single plane for a substrate part 110, a substrate part 120 and a connecting part 130 between substrate part 110 and substrate part 120.

Next, at step S200, a display 201a and display 203a are formed on substrate parts 120 and 120, respectively. Display 201a and display 203a have the same configuration (except their sizes may be different) are formed at the same time.

More in detail, at step S210, TFT 210 comprising gate electrode 211 and the drain electrode 212 is formed on substrate part 110 and substrate part 120.

At step S220, passivation layer 214, organic layer 215 and drain contact hole 216 are formed, and pixel electrode 220 is electrically connected drain electrode 212 through the drain contact hole 216.

Sealant 225 is applied to substrate part 110 and substrate part 120 where display 201a and 203a each are formed, and then the counter-substrates 240a and 240b comprising base substrates 242 are adhere thereto (S230). That is, the separate counter-substrates 240a and 240b are adhered to substrate part 110 and substrate part 120, respectively. This avoids the prior art technique which required a difficult procedure in which a single counter substrate had to be cut so as to form separate counter substrates.

In another embodiment, the counter counter-substrates 240a and 240b may be adhered to the substrate parts 110 and 120 after the sealant 225 is applied along the edges of the counter substrates 240a and 240b.

Liquid crystal layer 230 is interposed between substrate part 110 and counter-substrate 240a, and between substrate part 120 and the second counter counter-substrate 240b (S240).

Driving circuitry 500 is connected to one side of substrate part 110, thereby completing an LCD panel having substrate part 110 and display 201a and another LCD panel having substrate part 120 and display 203a.

Then, in step S300, connecting part 130 is bent (S300). Plastic insulating substrate 100 is flexible, so that it is easy to bend the connecting part 130. A bending angle may be in a range of 10 degrees and 190 degrees depending on arrangement of display 201a and display 203a, and is 180 degrees in the first embodiment. Accordingly, display 201a and display 203a face to outside, and substrate part 110 and substrate part 120 face parallel with each other.

Backlight unit 400 is disposed between substrate part 110 and substrate part 120, thereby completing the display device 1 for displaying the image on both sides (S400).

Thus, with the method of manufacturing according to the first embodiment of the present invention, a thin display device is provided which displays images on two sides.

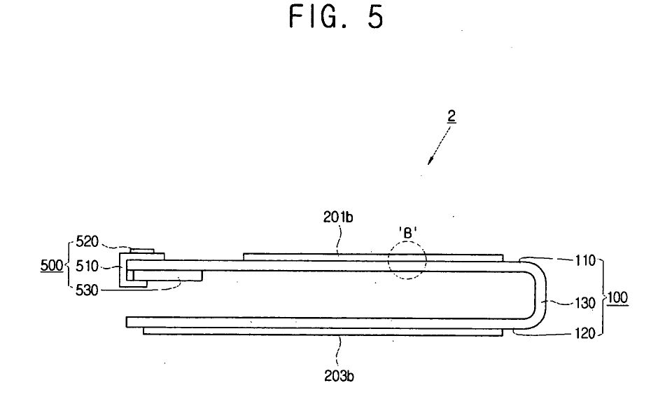

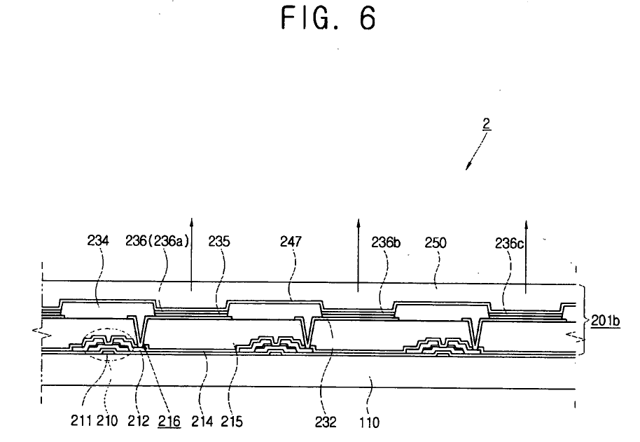

Hereinafter, a display device according to a second embodiment of the present invention will be described with reference to FIGS. 5 and 6. In the following description only the different features from those of the first embodiment will be described.

A display device 2 according to a second embodiment of the present invention is an organic light emitting diode (OLED) comprising a first display 201b and a second display 203b. Since the OLED emits light by itself, a backlight unit is not disposed between substrate parts 110 and 120. Thus, the display device 2 becomes even thinner.

The first display 201b is formed on substrate part 110. The first display 201b comprises a TFT 210 having a gate electrode 211 and a drain electrode 212, a pixel electrode 232 electrically connected to the drain electrode 212, a wall 234 dividing between the pixel electrode 232, a light-emitting layer 236 formed on the pixel electrode 232, a common electrode 247 formed on the light-emitting layer 236, and an encapsulation member 250 formed on the common electrode 247. One OLED comprises substrate part 110 and the first display 201b, and the other OLED comprises substrate part 120 and the second display 203b.

In the OLED, a single pixel comprises two or more TFTs including a switching TFT and a driving TFT. FIG. 6 only shows the driving TFT. TFT 210 of the driving TFT shown in FIG. 6 comprises amorphous silicon as a semiconductor layer, but may comprise polysilicon or organic semiconductor.

The passivation layer 214 is formed on TFT 210. Passivation layer 214 is partially removed from TFT 210 to form a drain contact hole 216 exposing the drain electrode 212.

Organic layer 215 is formed on passivation layer 214. The organic layer 215 is partially removed from TFT 210 to form the drain contact hole 216 as well.

The pixel electrode 232 is formed on the organic layer 215. The pixel electrode 232 is an anode and provides a hole to the light-emitting layer 236. The pixel electrode 232 comprises an alloy of magnesium (Mg) and silver (Ag) or an alloy of calcium (Ca) and silver (Ag) and is connected to TFT 210 through the drain contact hole 216.

The wall 234 is formed on the pixel electrode 232 and the organic layer 215 and encompasses the pixel electrode 232. The wall 234 divides between the pixel electrodes 232 to define a pixel area. The wall 234 comprises photoresist having thermal resistance and solvent-resisting property, such as acrylic resin, polyimide resin or the like, an inorganic material, such as SiO₂ and TiO₂, or a double layer of an organic layer and an inorganic layer.

A hole-injecting layer 235 and a light-emitting layer 236, which are an organic layer of a polymer, are formed on a portion of the pixel electrode 232 not covered with the wall 234.

The hole-injecting layer 235 comprises a hole injecting material, such as poly-3,4-ethylenedioxythiophene (PEDOT) and poly styrenesulfonate (PSS) and is formed by an ink-jet method in an aqueous suspension state.

The light-emitting layer 236 comprises sub-layers 236a, 236b and 236c emitting red light, green light and blue light respectively, and alternately disposed in the pixel area. The light-emitting layer 236 may be formed by an ink-jet method and comprises polyfluorene derivatives, poly(p-phenylene vinylene) derivatives, polyphenylene derivatives, poly(N-vinylcarbazole) derivatives and poly thiophene derivatives or compounds thereof doped with a perillene group pigment, rhodamine, rubrene, perillene, 9,10-diphenylanthracene, tetraphenylbuta, tetraphenylbutadiene, nile red, cumarine 6, quinacridone and etc.

Holes transmitted from the pixel electrode 232 and electrons transmitted from the common electrode 247 are combined each other in the light-emitting layer 236 to become excitons, and then the excitons generate light while inactivated.

The common electrode 247 is disposed on the wall 234 and the light-emitting layer 236. The common electrode 247 is a cathode and provides electrons to the light-emitting layer 236.

The OLED 2 according to the present embodiment has a top-emission structure, and thus the common electrode 247 should be transparent.

The common electrode 247 may comprise ITO or IZO. Alternatively, the common electrode 247 may comprise an alloy of magnesium and silver or an alloy of calcium and silver, and is in a range of 50 nm and 200 nm in the thickness. If the common electrode 247 is less than 50 nm thick, resistance becomes excessively high so that a common voltage may not be efficiently applied. If the common electrode 247 is more than 200 nm thick, it may become opaque. Preferably, the common electrode 247 transmits light 50% or more.

The encapsulation member 250 is formed on the common electrode 247 to protect the common electrode 247 and to prevent moisture and air from penetrating into the light-emitting layer 236. The encapsulation member 250 may comprise a sealing resin or a sealing can.

The display device 2 according to the second embodiment of the present invention obtains the same effect as the display device according to the first embodiment of the present invention and becomes even thin.

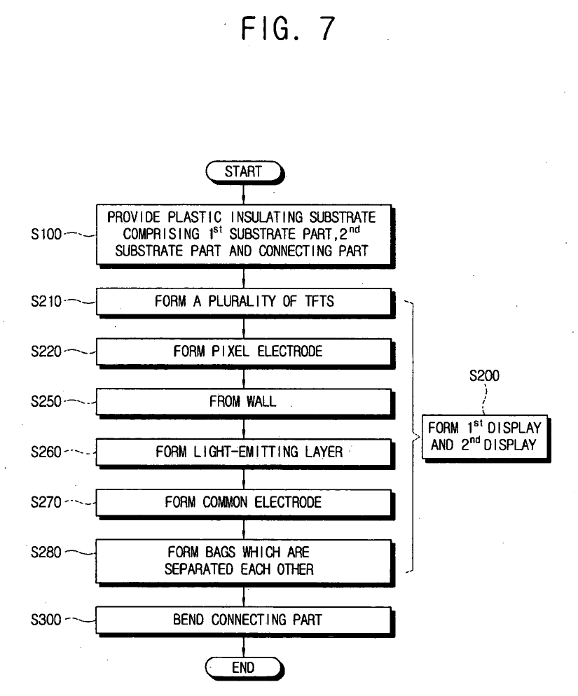

Hereinafter, a method of manufacturing a display device according to the second embodiment of the present invention will be described with reference to FIGS. 5 through 7 focusing on differences from the method of manufacturing the display device according to the first embodiment of the present invention. FIG. 7 is a flow chart to illustrate the method of manufacturing the display device according to the second embodiment of the present invention.

A method of manufacturing a display device 2 according to the second embodiment of the present invention is the same as the first embodiment until a plastic insulating substrate 100 is provided (S100) and the first display 201b and the second display 203b are formed thereon. However, two TFTs, the switching TFT and the driving TFT, are formed in each pixel in the second embodiment.

Then, the wall 234 is formed to divide between the pixel electrodes 232 and cover the drain contact hole 216 (S250). A wall forming layer (not shown) is formed and exposed to form the wall 234. The wall forming layer comprises photoresist and is formed by a slit coating method or a spin coating method. Then, the wall forming layer is exposed and developed to complete the wall 234. The wall 234 becomes lower than the wall forming layer during development.

The hole-injecting layer 235 and the light-emitting layer 236, which are an organic layer, are formed on the pixel electrode 232 (S260).

A hole-injecting solution (not shown comprising a hole-injecting material is dropped to the pixel electrode 232 by an ink-jet method and dried to remove a solvent therefrom, thereby forming the hole-injecting layer 235.

A light-emitting solution (not shown) comprising a light-emitting material is dropped to the pixel electrode 232 where the hole-injecting layer is formed 235 by an ink-jet method and dried to remove a solvent therefrom, thereby forming the light-emitting layer 236.

Then, the common electrode 247 comprising a transparent conductive material, such as ITO or IZO, is deposited on the light-emitting layer 236 by a sputtering method to be 50 nm to 200 nm thick (S270).

Each encapsulation member 250 is formed on the common electrode 247 disposed on substrate part 110 and on the common electrode 247 disposed on substrate part 120 (S280). If the encapsulation member 250 is a sealing can, the sealing can should adhere to substrate part 110 and substrate part 120 separately so as to bend the connecting part 130. However, if the encapsulation member 250 is a flexible sealing resin, it is not necessary to form the bag 250 separately.

Driving circuitry 500 is connected to one side of substrate part 110, and the connecting part 130 disposed between substrate part 110 and substrate part 120 is bent, thereby completing an OLED capable of displaying an image on both sides (S300). A bending angle may be in a range of 10 degrees and 190 degrees depending on arrangement of the first display 201b and the second display 203b, and is 180 degrees in the second embodiment.

Since the OLED emits light by itself, a backlight unit is not disposed between a first substrate part 110 and a second substrate part 120. Thus, the display device 2 becomes even thin.

Thus, with the method of manufacturing the display device according to the second embodiment of the present invention, it is provided that the display device 2 displaying the image on various sides, which is even thin and has the high manufacturing efficiency.

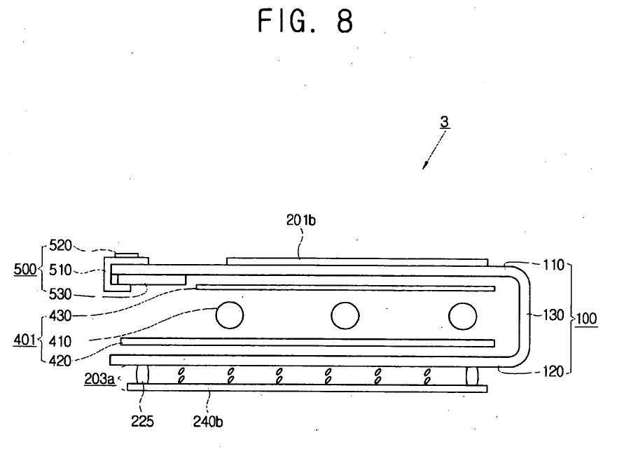

Hereinafter, a display device according to a third embodiment of the present invention will be described with reference to FIG. 8. FIG. 8 is a sectional view of a display device according to a third embodiment of the present invention.

A display device 3 according to a third embodiment of the present invention comprises an OLED to display one image on and an LCD to display another image on. The LCD comprises a second substrate part 120 and a second display 203a. Since light does not need to be provided to the OLED, the light control member 420 is not provided as a pair. Light control member 420 is disposed only toward the LCD, and a reflecting plate 430 is disposed toward a first substrate part 110 to reflect light.

The display device 3 according to the third embodiment of the present invention obtains the same effect as the display device according to the first embodiment of the present invention. Meanwhile, the backlight unit 401 is used to provide light to an LCD panel comprising the second substrate part 120 and display 203a. However, light emitted from the OLED may be provided to the LCD panel, and accordingly, the backlight unit 401 may not be provided.

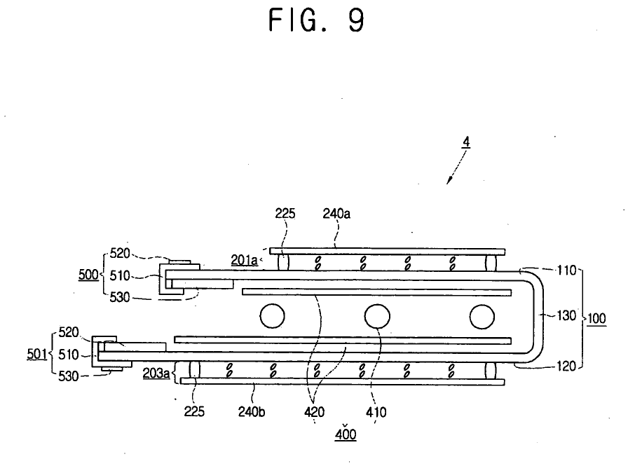

Next, a display device according to a fourth embodiment of the present invention will be described with reference to FIG. 9. FIG. 9 is a sectional view of a display device according to a fourth embodiment of the present invention.

A display device 4 according to a fourth embodiment of the present invention has the same configuration as the display device 1 according to the first embodiment except that an additional driving circuitry 501 is provided at one side of a second substrate part 120. Two driving circuitries 500 and 501 each drive respective displays 201a and 203a, and thus a signal line assembly 136 does not need to be formed in a connecting part 130. Thus, there is no problem even if the connecting part 130 is bent excessively since there is no signal line assembly 136 to be cut.

The display device 4 according to the fourth embodiment of the present invention obtains the same effect as the display device 1 according to the first embodiment of the present invention.

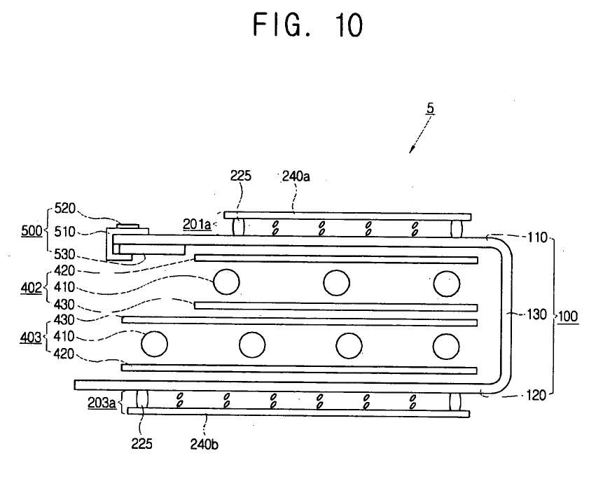

Hereinbelow, a display device according to a fifth embodiment of the present invention will be described with reference to FIG. 10. FIG. 10 is a sectional view of a display device according to a fifth embodiment of the present invention.

A display device 5 according to a fifth embodiment of the present invention has the same configuration as the display device 1 according to the first embodiment except that backlight units 402 and 403 are provided as a pair to provide light to a first display 201a and a second display 203a respectively. Accordingly, brightnesses in both displays 201a and 203a are improved.

The display device 5 according to the fifth embodiment of the present invention obtains the same effect as the display device 1 according to the first embodiment of the present invention.

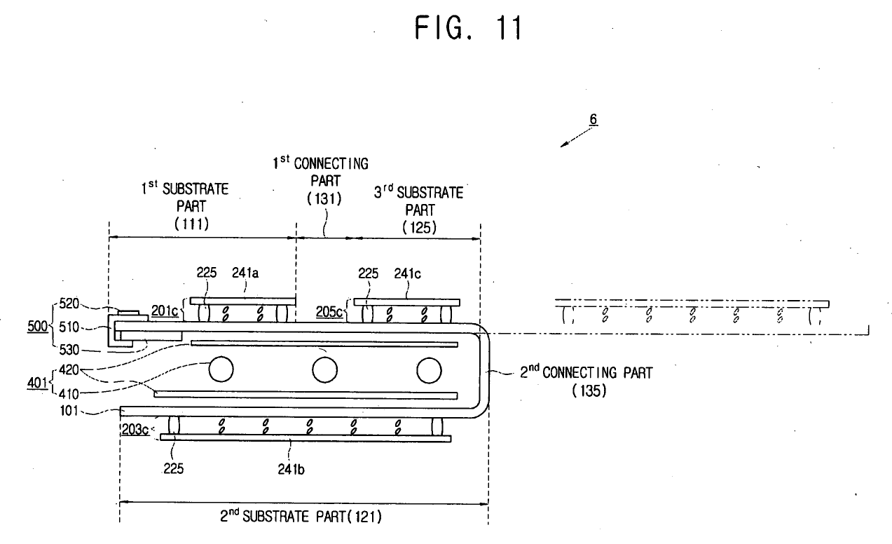

Hereinafter, a display device according to a sixth embodiment of the present invention will be described with reference to FIG. 11. FIG. 11 is a sectional view of a display device according to a sixth embodiment of the present invention.

A display device 6 according to a sixth embodiment of the present invention has the same configuration as the display device 1 according to the first embodiment except that three substrate parts 111, 121 and 125 and three displays 201c, 203c and 205c are provided, and two connecting parts 131 and 135 are formed between the substrate parts 111, 121 and 125.

In an electronic equipment 700 shown in FIG. 15, an outer screen 722 may be provided as a pair. Thus, a first connecting part 131 is not bent and connects a first display 201c and a third display 205c which are the outer screens 722. A second connecting part 135 is bent to dispose a second display 203c to be an inner screen 721.

The display device 6 according to the sixth embodiment of the present invention obtains the same effect as the display device 1 according to the first embodiment of the present invention.

Meanwhile, the substrate parts 111, 121 and 125 and the displays 201c, 203c and 205c may be provided in four or more depending on the configuration and the number of the outer screen 722 and the inner screen 721 of the electronic equipment 700. Further, the connecting parts 131 and 135 may be bent, or only some of them are bent.

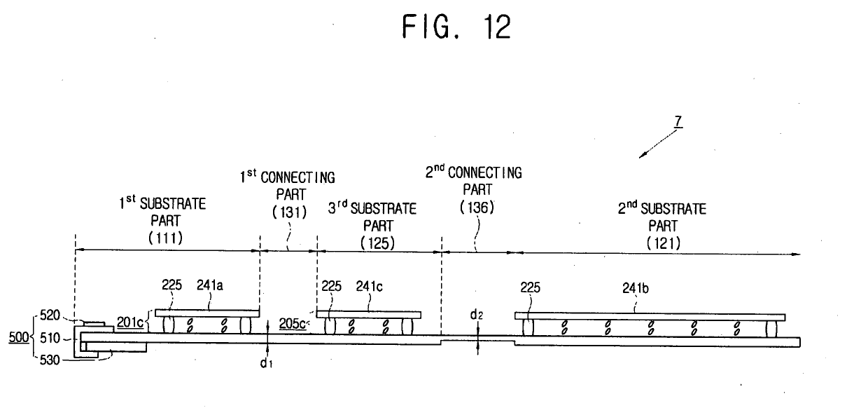

Hereinafter, a display device according to a seventh embodiment of the present invention will be described with reference to FIG. 12. FIG. 12 is a sectional view of a display device according to a seventh embodiment of the present invention.

A display device 7 according to a seventh embodiment of the present invention has the same configuration as the display device 6 according to the sixth embodiment except that the thickness d2 of a second connecting part 203, where a plastic insulating substrate 102 is bent, is thinner than the thickness d1 of the other part. Thus, the plastic insulating substrate 102 is easily bent.

The display device 7 according to the seventh embodiment of the present invention obtains the same effect as the display device 6 according to the sixth embodiment of the present invention.

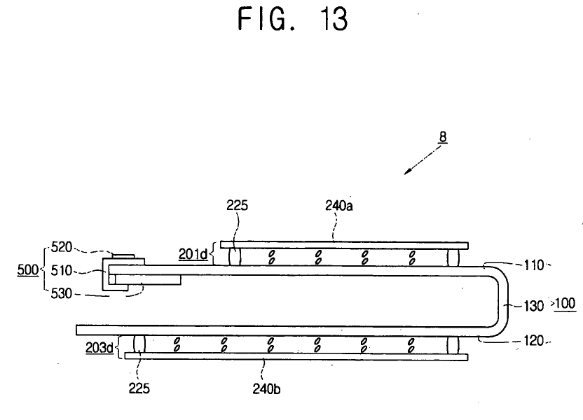

Hereinafter, a display device according to an eighth embodiment of the present invention will be described with reference to FIG. 13. FIG. 13 is a sectional view of a display device according to an eighth embodiment of the present invention.

In a display device 8 according to an eighth embodiment of the present invention, displays 201d and 203d are provided as a reflective type LCD panel which use external light. Accordingly, the backlight unit is not necessary in the display device 8, so that the display device 8 becomes even slim. Meanwhile, the displays 201d and 203d are manufactured by a known method.

The display device 8 according to the eighth embodiment of the present invention obtains the same effect as the display device 1 according to the first embodiment of the present invention.

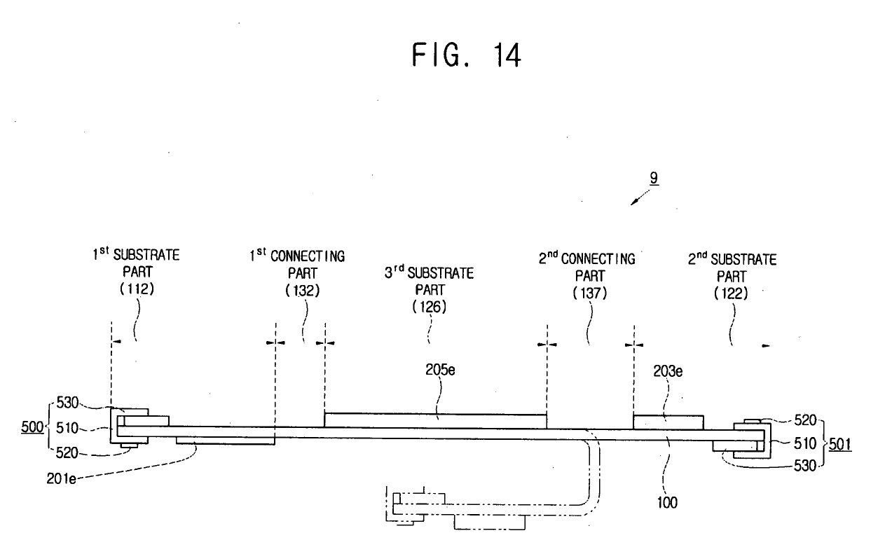

Hereinafter, a display device according to a ninth embodiment of the present invention will be described with reference to FIG. 14. FIG. 14 is a sectional view of a display device according to a ninth embodiment of the present invention.

In a display device 9 according to a ninth embodiment of the present invention, a first display 201e on a first substrate part 112 is disposed on a first surface of a plastic insulating substrate 100, and a second display 203e on a second substrate part 122 and a third display 205e on a third substrate part 126 are disposed on a second surface of plastic insulating substrate 100. Further, driving circuitry 500 is connected to the first substrate part 112 to apply a driving signal to the first display 201e, and an additional driving circuitry 501 is connected to the second substrate part 122 to apply a driving signal to the second display 203e and the third display 205e.

When a second connecting part 137 is bent, the first display 201e and the second display 203e becomes an outer screen 722 of an electronic equipment, and the third display 205e becomes an inner screen 721. Meanwhile, the displays 201e, 203e and 205e may be either an OLED or an LCD.

The display device 9 according to the ninth embodiment of the present invention obtains the same effect as the display device 1 according to the first embodiment of the present invention.

FIG. 15 is a perspective view of an electronic equipment comprising the display devices 1, 2, 3, 4, 5, 6, 7, 8 and 9 according to the present invention.

An electronic equipment 700 shown in FIG. 15 is a folder type cellular phone, which comprises a main body 710 having a key pad 711 and a display 720 rotatably connected to the main body 710 and displaying an image.

The display 720 comprises an inner screen 721 which is relatively large and displays the image when the electronic equipment 700 is unfolded and an outer screen 722 which is relatively small and displays the image when the electronic equipment 700 is folded. The inner screen 721 and the outer screen 722 may be provided in two or more respectively.

The display devices 1, 2, 3, 4, 5, 6, 7, 8 and 9 according to the present invention are mounted in the display 720 to become the inner screen 721 and the outer screen 722. If the electronic equipment 700 comprises the display devices 1, 2, 3, 4, 5, 6, 7, 8 and 9 according to the present invention, it is manufactured simply and conveniently and becomes thin.

The embodiments described above may be modified variously. The display devices 1, 2, 3, 4, 5, 6, 7, 8 and 9 according to the aforementioned embodiments of the present invention display the image on both sides, but may display the image on three or more sides. Meanwhile, a direct-type backlight unit is used in the embodiments, but an edge-type backlight unit may be available as well. Further, the light-emitting layer 236 comprises a polymer in the embodiments, but may comprise a low molecule material as well. If the light-emitting layer 236 comprises the low molecule material, it may be formed by an evaporation method.

Although a few embodiments of the present invention have been shown and described, it will be appreciated by those skilled in the art that changes may be made in these embodiments without departing from the spirit and scope of the invention.

What is claimed is:

1. A display device comprising:
a plastic insulating substrate;
a plurality of insulating substrates disposed opposite to the plastic insulating substrate; and
a plurality of TFTs formed on the plastic insulating substrate.

2. The display device according to claim 1, wherein some of the plurality of insulating substrates are disposed on a first surface of the plastic insulating substrate, and the others thereof are disposed on a second surface of the plastic insulating substrate.

3. The display device according to claim 1, wherein at least a pair of the insulating substrates have different sizes.

4. The display device according to claim 1, further comprising a liquid crystal layer interposed between the plastic insulating substrate and the plurality of insulating substrates.

5. The display device according to claim 1, further comprising a backlight unit, the plastic insulating substrate being disposed between the backlight unit and the plurality of insulating substrates.

6. The display device according to claim 4, further comprising a color filter layer formed on the plurality of insulating substrates.

7. The display device according to claim 5, further comprising a color filter layer formed on the plurality of insulating substrates.

8. The display device according to claim 1, wherein the plurality of insulating substrates are disposed at a predetermined interval, and the plastic insulating substrate comprises a connecting part corresponding to the predetermined interval.

9. The display device according to claim 8, wherein the connecting part is bent.

10. The display device according to claim 8, wherein a bending angle is in a range of 10 degrees and 190 degrees.

11. The display device according to claim 9, wherein at least a pair of the insulating substrates are disposed parallel with each other across the plastic insulating substrate.

12. The display device according to claim 8, wherein the connecting part is provided plurally, and at least a pair of the connecting parts have different thicknesses.

13. The display device according to claim 8, wherein a driving circuitry applying a driving signal is connected to one side of the plastic insulating substrate.

14. The display device according to claim 13, further comprising a signal line assembly transmitting the driving signal applied from the driving circuitry and formed in the connecting part.

15. A display device comprising:
a plastic insulating substrate having one or more connecting part; and
a plurality of displays formed on the plastic insulating substrate the connecting part being disposed therebetween.

16. The display device according to claim 15, wherein some of the plurality of displays are formed on a first surface of the plastic insulating substrate, and the others thereof are formed on a second surface of the plastic insulating substrate.

17. The display device according to claim 15, wherein at least a pair of the displays have different sizes.

18. The display device according to claim 15, wherein a driving circuitry applying a driving signal is connected to one side of the plastic insulating substrate.

19. The display device according to claim 18, wherein a signal line assembly transmitting the driving signal applied from the driving circuitry and formed in the connecting part.

20. The display device according to claim 15, wherein at least one of the displays comprises a plurality of TFTs having a drain electrode; a pixel electrode electrically connected to the drain electrode; a light-emitting layer formed on the pixel electrode; and a common electrode formed on the light-emitting layer.

21. The display device according to claim 20, wherein at least one of the displays further comprises a wall dividing between the pixel electrodes.

22. The display device according to claim 15, wherein the connecting part is provided plurally, and at least a pair of connecting parts have different thicknesses.

23. The display device according to claim 15, wherein at least one of the connecting parts is bent.

24. The display device according to claim 23, wherein a bending angle is in a range of 10 degrees and 190 degrees.

25. The display device according to claim 23, wherein at least a pair of the displays are disposed parallel with each other on opposite sides of the plastic insulating substrate.

26. A method of manufacturing a display device comprising:
providing a plastic insulating substrate having at least one connecting part and where a plurality of TFTs are formed;
adhering a plurality of insulating substrates to the plastic insulating substrate to face each other, the connecting part being disposed therebetween; and
bending at least one connecting part so that a plurality of displays face to outside.

27. The method of manufacturing the display device according to claim 26, wherein some of the plurality of insulating substrates are disposed on a first surface of the plastic insulating substrate, and the others thereof are disposed on a second surface of the plastic insulating substrate.

28. The method of manufacturing the display device according to claim 26, wherein a bending angle is in a range of 10 degrees and 190 degrees.

29. The method of manufacturing the display device according to claim 26, wherein at least a pair of the insulating substrates are disposed parallel with each other on opposite sides of the plastic insulating substrate.

30. The method of manufacturing the display device according to claim 26, further comprising interposing a liquid crystal layer between the plurality of insulating substrates and the plastic insulating substrate.

31. The method of manufacturing the display device according to claim 26, after bending the connecting part, further comprising disposing a backlight unit between the pair of the insulating substrates which are disposed parallel with each other.

32. The method of manufacturing the display device according to claim 26, after adhering the plurality of insulating substrates to the plastic insulating substrate, further comprising disposing a backlight unit to disposed the plastic insulating substrate between the backlight unit and the plurality of insulating substrates.

33. The method of manufacturing the display device according to claim 26, wherein the connecting part is provided plurally, and at least a pair of connecting parts are formed to have different thicknesses.

34. A method of manufacturing a display device comprising:
providing a plastic insulating substrate comprising at least one connecting part and a plurality of TFTs each having a drain electrode;
forming a plurality of displays on the plastic insulating substrate, the connecting part being disposed therebetween; and
bending at least one connecting part so that the plurality of displays face to outside.

35. The method of manufacturing the display device according to claim 34, wherein a bending angle is in a range of 10 degrees and 190 degrees.

36. The method of manufacturing the display device according to claim 34, wherein at least a pair of the insulating substrates are disposed parallel with each other across the plastic insulating substrate.

37. The method of manufacturing the display device according to claim 34, wherein the connecting part is provided plurally, and at least a pair of connecting parts are formed to have different thicknesses.

38. The method of manufacturing the display device according to claim 34, wherein the forming the displays comprises forming a pixel electrode electrically connected to the drain electrode; forming a light-emitting layer on the pixel electrode; and forming a common electrode on the light-emitting layer.

39. The method of manufacturing the display device according to claim 38, further comprising forming a wall dividing between the pixel electrodes on the TFTs.
